(19) United States
(12) Patent Application Publication
(10) Pub. No.: US 2007/0168135 A1
(43) Pub. Date: Jul. 19, 2007

(54) Biological data set comparison method

(76) Inventors: Pankaj Agarwal, King of Prussia, PA (US); William Charles Reisdorf Jr, King of Prussia, PA (US); Sujoy Ghosh, Durham, NC (US); Vinod D. Kumar, King of Prussia, PA (US); Mark Robert Hurle, King of Prussia, PA (US); Karen Stephanie Kabnick, King of Prussia, PA (US); Paul Robert McAllister, King of Prussia, PA (US); David Burdette Searls, King of Prussia, PA (US); Kay Satoshi Tatsuoka, King of Prussia, PA (US); Liwen Liu, Durham, NC (US); Michal Magid-Slav, King of Prussia, PA (US); Dmitri V Zaykin, Raleigh, NC (US)

Correspondence Address: GLAXOSMITHKLINE;CORPORATE INTELLECTUAL PROPERTY, MAI B475, FIVE MOORE DR., PO BOX 13398, RESEARCH TRIANGLE PARK, NC, 27709-3398, US

(21) Appl. No.: 10/562,096

(22) PCT Filed: Jun. 22, 2004
(86) PCT No.: PCT/US04/19932

§ 371 Date: Dec. 21, 2005

Related U.S. Application Data
(60) Provisional application No. 60/482,420, filed on Jun. 25, 2003.

(51) Int. Cl. G06F 19/00

(52) U.S. Cl. 702/19

(57) ABSTRACT

A method of identifying a relationship between a set of one or more candidate biomolecules and a set of one or more reference biomolecules, the method including inputting to a computer a query set describing the one or more candidate biomolecules; comparing the query set with a target database describing the one or more reference biomolecules wherein the one or more reference biomolecules grouped into one or more buckets and wherein the one or more reference biomolecules of each bucket share a common property; counting a number of matches between each query set and each buckets of the target database; and statistically analyzing the number of matches to each bucket wherein the presence of a statistically significant match identifies a relationship between a the query set and a bucket of the target database.

### TECHNICAL FIELD

The technical field relates to methods of identifying common properties within a set of biomolecules and properties that connect two or more sets of biomolecules, and also relates to methods for deriving functional explanations or hypotheses to explain the relationship between a set of biomolecules (e.g., genes, proteins) and between multiple sets of biomolecules.

Table Of Abbreviations

| | |
|---|---|
| 3D | three-dimensional |
| BIOS | basic input/output system |
| BLAST | Basic Local Alignment Search Tool |
| CGI | common gateway interface |
| cM | centimorgan |
| DNA | deoxyribonucleic acid |
| HSPs | high scoring sequence pairs |
| LAN | local area network |
| LOD | Log of the odds ratio |
| NCBI | National Center for Biotechnology |
| | Information |
| NLM | National Library of Medicine |
| PCR | polymerase chain reaction |
| PNA | peptide nucleic acid |
| OMIM | Online Mendelian Inheritance in Man |
| RAM | random access memory |
| rmsd | root-mean-squared distance |
| RNA | ribonucleic acid |
| ROM | read only memory |
| SAN | system area network |
| URL | uniform resource locator |
| USB | universal serial bus |
| WAN | wide area network |

Amino Acid Abbreviations and Corresponding mRNA Codons

| Amino Acid | 3-Letter | 1-Letter | mRNA Codons |
|---|---|---|---|
| Alanine | Ala | A | GCA GCC GCG GCU |
| Arginine | Arg | R | AGA AGG CGA CGC CGG CGU |
| Asparagine | Asn | N | AAC AAU |
| Aspartic Acid | Asp | D | GAC GAU |
| Cysteine | Cys | C | UGC UGU |
| Glutamic Acid | Glu | E | GAA GAG |
| Glutamine | Gln | Q | CAA CAG |
| Glycine | Gly | G | GGA GGC GGG GGU |
| Histidine | His | H | CAC CAU |
| Isoleucine | Ile | I | AUA AUC AUU |
| Leucine | Leu | L | UUA UUG CUA CUC CUG CUU |
| Lysine | Lys | K | AAA AAG |
| Methionine | Met | M | AUG |
| Proline | Pro | P | CCA CCC CCG CCU |
| Phenylalanine | Phe | F | UUC UUU |
| Serine | Ser | S | ACG AGU UCA UCC UCG UCU |
| Threonine | Thr | T | ACA ACC ACG ACU |
| Tryptophan | Trp | W | UGG |
| Tyrosine | Tyr | Y | UAC UAU |
| Valine | Val | V | GUA GUC GUG GUU |

### BACKGROUND ART

Biomedical research is in the midst of an unprecedented data explosion. Complete genome sequences of prokaryotic organisms are appearing in the literature and on the World Wide Web on almost a weekly basis. See e.g., http://igweb.integratedgenomics.com/GOLD/. Several complete genomes from model eukaryotic organisms have also been sequenced, and many more sequencing projects are in various stages of planning and execution See e.g., hftp://www.nih.gov/science/models/. The sequence of the human genome is also now freely available in “finished” form. See e.g., http://www.ncbi.nlm.nih.gov/genome/guide/human/ or http://www.ensembl.org/Homo_sapiens/. Combined with the growing availability of high-throughput and genome-wide experimental methods, this deluge of data facilitates the potential for comparisons of sequence, structure, mRNA- or protein-expression levels, and function between all human genes and the genes of model organisms. It also opens up new challenges for determining the functional and cellular role for the many as yet uncharacterized genes within these organisms.

As research into genomics and proteomics progresses, experimental results are beginning to transcend a single gene of interest and are more commonly involving sets of genes or other biomolecules that behave in some sense “similarly” or share a common property. Although computational tools that allow for a comparison of one gene to all other known genes at the level of primary nucleic acid or amino acid sequence have existed for some time (e.g., BLAST; Altschul et al., 1990), such comparisons often do not yield sufficient information to allow for the identification of a specific function for that gene. Indeed, it is very common for genes that share little or no similarity at the nucleic acid sequence level to encode proteins that have related functions or roles. For example, two genes might encode enzymes that catalyze adjacent steps in the same biochemical pathway, and the functional disruption of either gene might lead to a similar outcome for the cell or organism (e.g., a human disease). These genes would be unlikely to exhibit similarity at the primary nucleic acid sequence level, and thus current search strategies would not identify these genes as being related despite the similar phenotype that would result from their functional disruption. By way of additional example, this problem is also encountered in areas such as transcriptome analysis, where lists of genes with similar expression levels or time-profiles are generated from each experiment. Thus, there persists a great need for computational methods for determining the underlying commonality among a set of genes and for ways of assigning consensus annotations to such gene sets.

One currently available approach for analyzing genes is a World Wide Web-based tool that collects and displays information gene-by-gene for a predefined set of genes, such as disease candidates by creating a “home page” for each gene in the set. Halushka et al., 1999. This and other approaches (see e.g., Bouton and Pevsner, 2000; Bouton and Pevsner, 2002; Khatri et al., 2002; Ostermeier et al., 2002) lack breadth and do not comprehensively address the universe of possible interactions, traits, and characteristics between genes.

Some other approaches involving text mining of published scientific abstracts have been developed for use in gene expression profiling (see e.g., Tanabe et al., 1999; Masys et al., 2001; Blaschke et al. 2001), or for finding links between genes and diseases (Jenssen et al., 2001; Perez-Iratxeta et al., 2002a). The latter group has recently demonstrated the feasibility of mining MEDLINE abstracts to generate lists of candidate genes that are believed to be associated with a group of inherited diseases. Perez-Iratxeta et al., 2002b.

Computational methods have been proposed that pertain to partitioning of genotype variation into clusters that predict quantitative trait variation, such as elevated plasma triglyceride levels. Nelson et al., 2001. An extension of this method has been used to uncover a combination of polymorphisms in several estrogen metabolism genes that correlates with increased sporadic breast cancer occurrence. Ritchie et al., 2001. A support-vector machine approach was employed to make gene functional classifications based on phylogenetic profiles and expression data. Pavlidis et al., 2002. Additionally, a graph theoretic method for combining microarray and data with protein interaction maps as a way of annotating sets of genes from transcriptome experiments has been described. del Rio et al., 2001.

While the above methods attempt to address the general problem of assigning consensus annotations to gene sets, these approaches do not offer a comprehensive solution to the problem of identifying the properties of a set of biomolecules and correlating these properties with other sets of biomolecules for which a common property has been defined.

What is needed, therefore, is a method of identifying various properties of a given set of biomolecules and correlating these properties with multiple sets of biomolecules that are common to a given biological process or pathway. Such a method would facilitate the characterization of a set of unknown biomolecules, including an assessment of the function of the unknown biomolecules. These and other problems are addressed herein.

### SUMMARY

Provided is a method of identifying a relationship between one or more candidate biomolecules and one or more reference biomolecules. In one embodiment, the method comprises: (a) inputting to a computer a query set describing the one or more candidate biomolecules; (b) comparing the query set with a target database describing the one or more reference biomolecules, wherein the one or more reference biomolecules are grouped into one or more buckets, and wherein the one or more reference biomolecules of each bucket share a common property; (c) counting a number of matches between each query set and each bucket of the target database; and (d) statistically analyzing each match, wherein the presence of a statistically significant match identifies a relationship between the query set and a bucket of the target database.

Also provided is a method of identifying a relationship between two or more region sets, each region set describing one or more candidate biomolecules, and a target database describing one or more reference biomolecules grouped into one or more buckets. In one embodiment, the method comprises: (a) providing a query set describing two or more region sets, each region set comprising one or more candidate biomolecule sequences extracted from one genetic region; (b) comparing the query set with target database sequences describing one or more reference biomolecule sequences, wherein the target database sequences grouped into one or more buckets, and wherein the one or more reference biomolecules of each bucket share a common property; (c) counting a number of matches between each query set and each bucket of the target database; and (d) statistically analyzing each match, wherein the presence of a statistically significant match identifies a relationship between the query set and a bucket of the target database. In one embodiment, the method further comprises (e) constructing a plurality of replicates of the one or more query sets; (f) modeling the replicates at random chromosomal locations to form a random location data set; (g) processing the random location data set by following steps (a)-(d); (h) quantifying the number of times each match is found to surpass a predetermined threshold to form a statistically significant set of random location matches; and (i) comparing the statistically significant set of random location matches to the statistically significant relationship of steps (a)-(d).

In various embodiments, query sets comprise one or more sequences, including, but not limited to, DNA, RNA, or protein sequences. In one embodiment, these sequences are derived from one genetic region. In one embodiment, the one or more candidate biomolecules and the one or more reference biomolecules are all selected from the group consisting of proteins, nucleic acids, and small molecules. In one embodiment, the comparing comprises employing a BLAST-based algorithm to identify similar or identical sequences. In one embodiment, the counting comprises applying one or more principles chosen from the group consisting of (a) each query set candidate sequence can match at most one reference sequence in any given bucket; (b) each query set candidate sequence can possess a match in one or more different buckets; and (c) once a candidate sequence in the query set matches a specific bucket reference sequence in the target database, any subsequent matches of that same candidate sequence to other reference sequences in that bucket do not increase the match count for the bucket. In one embodiment, the statistically analyzing comprises computing one or more statistics for each match, which can optionally be sorted and/or outputted to a webpage comprising one or more hyperlinks.

Also provided is a computer-readable medium having stored thereon a data structure having multiple data fields, comprising (a) a first data field containing data representing a bucket; (b) a second data field containing data representing a name for the bucket; and (c) a third data field containing data representing a list of members of the bucket, wherein the members have a common property.

Also provided is a method of making a target database. In one embodiment, the method comprises: (a) identifying a source of informative content; (b) arranging informative content from the source of informative content into a set of buckets, wherein the buckets are given names; (c) gathering the names of the buckets and a list of biomolecules present in each bucket; and (d) creating and loading into a database data fields containing data representing (i) the set of buckets; (ii) the list of biomolecules present in each bucket; and (iii) a description for each biomolecule present in each bucket. In one embodiment, the source of informative content is a publicly available database, including, but not limited to, SwissProt, TrEMBL, and NCBI. In one embodiment, the gathering is accomplished using a source-specific parsing script. In one embodiment, the creating and loading is accomplished using a database loading script. In one embodiment, the data representing a description for each biomolecule present in each bucket is selected from the group consisting of a nucleic acid sequence, an amino acid sequence, or an identification number, wherein the identification number allows for retrieval of a nucleic acid sequence or an amino acid sequence.

Also provided is a computer readable storage device embodying programs of instructions executable by a computer for performing the disclosed methods.

Accordingly, it is an object to provide a novel method for characterizing a set of biomolecules. This and other objects are achieved in whole or in part as disclosed herein.

An object having been stated hereinabove, other objects will be evident as the description proceeds, when taken in connection with the accompanying drawings and examples as best described hereinbelow.

### BRIEF DESCRIPTION OF THE DRAWINGS

FIG. 1 illustrates an exemplary general purpose computing platform 100 upon which the methods and systems disclosed herein can be implemented.

FIG. 2 is a flowchart of a process 200 for implementing the methods disclosed herein.

FIG. 3 is a flowchart of a process 300 for implementing a method of identifying a relationship between two or more regions sets.

FIG. 4 is a database relation diagram 400 showing exemplary data that is stored in each field and how the data in one field relates to the data in another field.

### DETAILED DESCRIPTION

The disclosed methods and data structures can be implemented in hardware, firmware, software, or any combination thereof. In one exemplary embodiment, the methods and data structures disclosed herein for classifying biomolecules can be implemented as computer readable instructions and data structures embodied in a computer-readable medium.

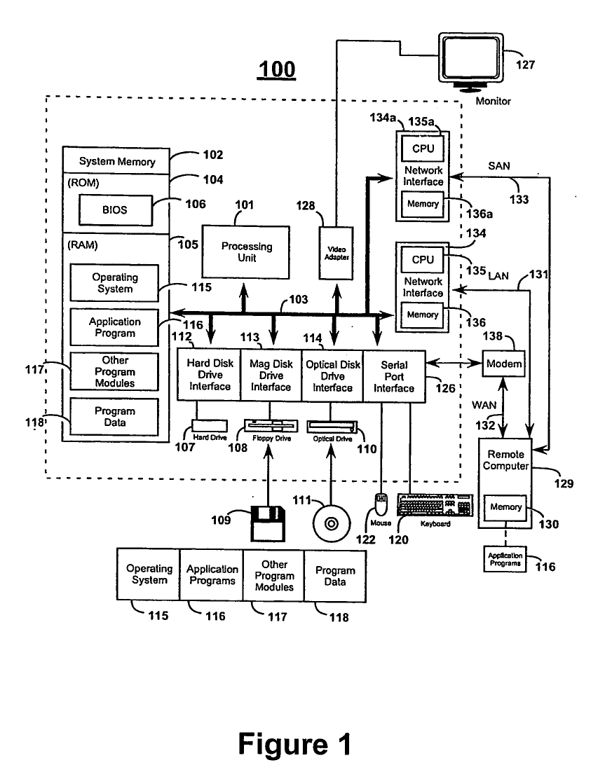

With reference to FIG. 1, an exemplary system includes a general purpose computing device in the form of a conventional personal computer 100, including a processing unit 101, a system memory 102, and a system bus 103 that couples various system components including the system memory to the processing unit 101. System bus 103 can be any of several types of bus structures including a memory bus or memory controller, a peripheral bus, and a local bus using any of a variety of bus architectures. The system memory includes read only memory (ROM) 104 and random access memory (RAM) 105. A basic inpuVoutput system (BIOS) 106, containing the basic routines that help to transfer information between elements within personal computer 100, such as during start-up, is stored in ROM 104. Personal computer 100 further includes a hard disk drive 107 for reading from and writing to a hard disk (not shown), a magnetic disk drive 108 for reading from or writing to a removable magnetic disk 109, and an optical disk drive 110 for reading from or writing to a removable optical disk 111 such as a CD ROM or other optical media.

Hard disk drive 107, magnetic disk drive 108, and optical disk drive 110 are connected to system bus 103 by a hard disk drive interface 112, a magnetic disk drive interface 113, and an optical disk drive interface 114, respectively. The drives and their associated computer-readable media provide nonvolatile storage of computer readable instructions, data structures, program modules, and other data for personal computer 100. Although the exemplary environment described herein employs a hard disk, a removable magnetic disk 109, and a removable optical disk 111, it will be appreciated by those skilled in the art that other types of computer readable media which can store data that is accessible by a computer, such as magnetic cassettes, flash memory cards, digital video disks, Bernoulli cartridges, random access memories, read only memories, and the like can also be used in the exemplary operating environment.

A number of program modules can be stored on the hard disk, magnetic disk 109, optical disk 111, ROM 104, or RAM 105, including an operating system 115, one or more applications programs 116, other program modules 117, and program data 118.

A user can enter commands and information into personal computer 100 through input devices such as a keyboard 120 and a pointing device 122. Other input devices (not shown) can include a microphone, touch panel, joystick, game pad, satellite dish, scanner, or the like. These and other input devices are often connected to processing unit 101 through a serial port interface 126 that is coupled to the system bus, but can be connected by other interfaces, such as a parallel port, game port or a universal serial bus (USB). A monitor 127 or other type of display device is also connected to system bus 103 via an interface, such as a video adapter 128. In addition to the monitor, personal computers typically include other peripheral output devices, not shown, such as speakers and printers. The user can use one of the input devices to input data indicating the user's preference between alternatives presented to the user via monitor 127.

Personal computer 100 can operate in a networked environment using logical connections to one or more remote computers, such as a remote computer 129. Remote computer 129 can be another personal computer, a server, a router, a network PC, a peer device or other common network node, and typically includes many or all of the elements described above relative to personal computer 100, although only a memory storage device 130 has been illustrated in FIG. 1. The logical connections depicted in FIG. 1 include a local area network (LAN) 131, a wide area network (WAN) 132, and a system area network (SAN) 133. Local- and wide-area networking environments are commonplace in offices, enterprise-wide computer networks, intranets and the Internet.

System area networking environments are used to interconnect nodes within a distributed computing system, such as a cluster. For example, in the illustrated embodiment, personal computer 100 can comprise a first node in a cluster and remote computer 129 can comprise a second node in the cluster. In such an environment, it is preferable that personal computer 100 and remote computer 129 be under a common administrative domain. Thus, although computer 129 is labeled “remote”, computer 129 can be in close physical proximity to personal computer 100.

When used in a LAN or SAN networking environment, personal computer 100 is connected to local network 131 or system network 133 through network interface adapters 134 and 134a. Network interface adapters 134 and 134a can include processing units 135 and 135a and one or more memory units 136 and 136a.

When used in a WAN networking environment, personal computer 100 typically includes a modem 138 or other device for establishing communications over WAN 132. Modem 138, which can be internal or external, is connected to system bus 103 via serial port interface 126. In a networked environment, program modules depicted relative to personal computer 100, or portions thereof, can be stored in the remote memory storage device. It will be appreciated that the network connections shown are exemplary and other approaches to establishing a communications link between the computers can be used.

I. Definitions

Following long-standing patent law convention, the terms “a” and “an” mean “one or more” when used in this application, including the claims.

As used herein, the term “about,” when referring to a value or to an amount of mass, weight, time, volume, concentration or percentage is meant to encompass variations of ±20% or ±10%, in another example ±5%, in another example ±1%, and in still another example ±0.1% from the specified amount, as such variations are appropriate to perform the disclosed method.

As used herein, the terms “amino acid” and “amino acid residue” are used interchangeably and mean any of the twenty naturally occurring amino acids. An amino acid is formed upon chemical digestion (hydrolysis) of a polypeptide at its peptide linkages. In keeping with standard polypeptide nomenclature, abbreviations for amino acid residues are shown in tabular form presented hereinabove. In addition, the phrases “amino acid” and “amino acid residue” are broadly defined to include modified and unusual amino acids.

As used herein, the term “biomolecule” means any molecule isolated from, derived from, or based on a molecule found in a living organism, including viruses. The term biomolecule includes, but is not limited to, both proteins and nucleic acids (RNA and DNA). Biomolecules can be polymeric in nature and can comprise a unique sequence of monomers; for example, a biomolecule can comprise a nucleic acid (e.g., a gene, and fragments thereof), an amino acid, a derivatized protein (e.g., a glycosylated protein), a nucleic acid comprising a nucleic acid analog, a peptide nucleic acid (PNA), an antibody, as well as peptides, polypeptides, proteins and fragments thereof. As used herein, the term “biomolecule” also refers to any molecule that is capable of producing a biological effect or participating in a biological process. In this context, a biomolecule includes, but is not limited to, a small molecule such as a drug.

As used herein, the term “BLAST-formatted database” means a database wherein the data representing a nucleic acid or amino acid sequence of a candidate or reference biomolecule is in a form amenable to manipulation by BLAST and BLAST-based algorithms. The proper form for such sequences is described in Altschul et al., (1990). See also http://blast.wustl.edu/doc/FAQ-Indexing.html. The BLAST-formatted database acts as a master repository for all nucleic acid and amino acid sequences. It includes data entries for nucleic acid and amino acid sequences corresponding to all reference biomolecules as well as identification or accession numbers by which these sequences can be accessed for use in the methods and devices disclosed herein. In addition, data is automatically added to the BLAST-formatted database corresponding to the nucleic acid and amino acid sequences of all candidate biomolecules.

As used herein, the term “bucket” means any grouping of biomolecules (e.g., genes or gene products) that share a biological property. For example, a gene or gene product can have an identifier and/or an associated sequence (amino acid or nucleic acid). In one example, an identifier is a standard name for the gene or gene product (e.g., “human beta-globin”). In another example, the identifier is an identification number or an accession number that allows the sequence of the gene or gene product to be retrieved from a source (e.g., the NCBI accession number for the human beta-globin complete coding sequence is AF007546). A source includes, but is not limited to a public or private database. The identifier need not be unique, and a given gene can be a member of one or more buckets.

Each bucket can have a unique name, which can also indicate its origin and/or creator. Buckets and collections of buckets can be created by individuals or they can be defined as the results from various types of analyses. For example, a bucket can comprise a set of genes found to be more highly expressed in a particular tumor cell compared with a normal cell. Buckets can also be created from public-domain databases. As an additional example, a bucket can include all the component enzymes in a metabolic pathway, all the protein components in a signaling pathway, biomolecules mentioned in the same publication, biomolecules mentioned in publications on the same subject, sets of proteins sharing a particular sequence motif or domain, sets of genes known to be present on an oligonucleotide array or chip, genes classified into particular categories according to an ontology, gene products present in a particular tissue or organ or subcellular location, or genes in which a particular keyword occurs somewhere in their associated annotations. A bucket can form an element of a target database.

As used herein, the term “bucket source” means any medium or entity to which the origin of the bucket can be traced. For example, a bucket source can be a user. In another example, a bucket source can be a database. In yet another example, a bucket source can be the results of a search of a database done with user-specified parameters. Defining a bucket source can be useful as an approach for identifying different buckets that have the same name. The use of bucket sources also allows broad categories of buckets to be defined, such as “pathway” or “function” buckets.

As used herein, the terms “candidate biomolecule” and “candidate sequence” are used interchangeably, and mean a biomolecule or sequence that is part of a query set to be compared to a target database. Candidate biomolecules are ones that the user is attempting to characterize as having or not having the various properties that are represented by the buckets of the target database. This characterization is accomplished by comparing a candidate biomolecule to the reference biomolecules of the target database and statistically analyzing the number of matches that result from the comparison. When a statistically significant match (of the query set) is found to a particular bucket, the user can infer that the candidate biomolecule has the property that is common to the reference biomolecules that are members of the bucket to which the match was made.

As used herein, the terms “describing” and “description” as they relate to biomolecules mean any categorization of the biomolecule that relates to its identity or to a property it possesses. In one example, a biomolecule can be described by its common name, such as “human beta-globin”, “mouse erythropoietin receptor”, “Drosophila fushi tarazu”, etc. In another example, a biomolecule can be described by its nucleic acid or amino acid sequence. In another example, a biomolecule can be described by an identification number or accession number that allows its corresponding nucleic acid and/or amino acid sequence to be retrieved from a source such as a public or private database. In yet another example, a biomolecule can be described by a property that it possesses. In one example, a property can be a functional description of the biomolecule such as “kinase”, “receptor”, “cytokine”, “oncogene”, “ligand”, etc. In another example, a property can include the organism from which the biomolecule was isolated. In another example, the property can include a biochemical pathway in which the gene product plays a role including, but not limited to pyrimidine biosynthesis, the citric acid cycle, fatty acid biosynthesis, the pentose cycle, amino acid biosynthesis, etc. In yet another example, the property can include a three-dimensional (3D) structural feature of the biomolecule. Several ways of incorporating structural information into a search exist including, but not limited to creating sets of buckets based on public databases that impose a structural hierarchy on those proteins with known three-dimensional structures. Exemplary public databases include CATH (http://www.biochem.ucl.ac.uk/bsm/cath_new/index. html) and SCOP (hftp://scop.berkeley.edu/). It is generally believed that proteins with at least 30% overall amino acid identity are likely to fold into very similar structural conformations (McGuffin & Jones 2002).

A more general method might be to reduce or project known 3D structures to a sequence-like character string, comprising the secondary structure adopted by each amino acid (e.g., hhhhhhhhhsssshhhhhhhhhhhhh as a helix-loop-helix motif). A BLAST-like method could optionally be used to compare the length and order of secondary-structural elements of known proteins. Secondary structure predictions for proteins with no known structure could also be compared to those of a database of known structures (see Aurora & Rose 1998).

Yet another possibility is to create structure-specific buckets by computing a root-mean-squared distance (rmsd) measure between the 3D structural coordinates of any two proteins. For example, buckets for all structures within 2 Å rmsd of each other could be defined.

As used herein, the phrase “extracted from one genetic region” refers to sequences derived from genes that are present in a contiguous region of a genome or to protein sequences that are encoded by sequences derived from genes that are present in a contiguous region of a genome. “One genetic region” and “the same region of a genome” include, but are not limited to a chromosome, an arm of a chromosome, a portion of a chromosome contained between two markers, and a band of a chromosome as visualized by banding techniques that are known in the art such as Giemsa banding. These terms also include any other measure of physical proximity on a chromosome, including but not limited to a kilobase, a megabase, or a centimorgan (cM).

As used herein, the term “mutation” carries its traditional connotation and means a change, inherited, naturally occurring, or introduced, in a nucleic acid or polypeptide sequence, and is used in its sense as generally known to those of skill in the art. A mutation can be any (or a combination of) detectable, unnatural change affecting the chemical or physical constitution, mutability, replication, phenotypic function, or recombination of one or more deoxyribonucleotides. Nucleotides can be added, deleted, substituted for, inverted, or transposed to new positions with and without inversion. Mutations can occur spontaneously and can be induced experimentally by application of mutagens. A mutant variation of a nucleic acid molecule results from a mutation. A mutant polypeptide can result from a mutant nucleic acid molecule and can also refer to a polypeptide that is modified at one or more amino acid residues from the wild-type (i.e., naturally occurring) polypeptide. For example, the mutation can be a point mutation or the addition, deletion, insertion, and/or substitution of one or more nucleotides, or any combination thereof. The mutation can be a missense or frameshift mutation. Modifications can be, for example, conserved or non-conserved, natural or unnatural.

As used herein, “nucleic acid” and “nucleic acid molecule” refer to any of deoxyribonucleic acid (DNA), ribonucleic acid (RNA), oligonucleotides, fragments generated by the polymerase chain reaction (PCR), and fragments generated by any of ligation, scission, endonuclease action, and exonuclease action. Nucleic acids can comprise monomers that are naturally occurring nucleotides (such as deoxyribonucleotides and ribonucleotides), or analogs of naturally occurring nucleotides (e.g., α-enantiomeric forms of naturally occurring nucleotides), or a combination of both. Modified nucleotides can have modifications in sugar moieties and/or in pyrimidine or purine base moieties. Sugar modifications include, for example, replacement of one or more hydroxyl groups with halogens, alkyl groups, amines, and azido groups. Sugars can also be functionalized as ethers or esters. Moreover, the entire sugar moiety can be replaced with sterically and electronically similar structures, such as aza-sugars and carbocyclic sugar analogs. Examples of modifications in a base moiety include alkylated purines and pyrimidines, acylated purines or pyrimidines, or other well-known heterocyclic substitutes. Nucleic acid monomers can be linked by phosphodiester bonds or analogs of phosphodiester bonds. Analogs of phosphodiester linkages include phosphorothioate, phosphorodithioate, phosphoroselenoate, phosphorodiselenoate, phosphoroanilothioate, phosphoranilidate, phosphoramidate, and the like. The term “nucleic acid” also includes so-called “peptide nucleic acids,” which comprise naturally occurring or modified nucleic acid bases attached to a polyamide backbone. Nucleic acids can be either single stranded or double stranded.

As used herein, the term “property” denotes any feature of a biomolecule. Properties include, but are not limited to, sequence similarity and/or identity, chromosomal location, involvement in a particular biochemical pathway, association with genetic disease, expression in a context, three-dimensional structural features, and having or encoding a particular functional domain. Representative functional domains include, but are not limited to, kinase domains, growth factor binding domains, phosphorylation sites, glycosylation sites, protein and/or nucleic acid binding sites, protein-protein interaction domains, and post-translational modification sites.

As used herein, the term “quality checking” means the application of subjective criteria to assess the usefulness of a bucket. Quality checking ensures that all reference biomolecules that have been grouped into a bucket share the common property used to describe the bucket. These criteria attempt to take into account the nature of the data analysis involved in assembling the bucket. For example, reliable human-annotated sources (e.g., the SwissPmt database) would receive a higher rank than a set generated by some automated computational procedure.

As used herein, the term “query set” means any item or group of items arranged in such a way as to allow for comparison to a target database. By way of example and not limitation, a query set can include a nucleic acid sequence, an amino acid sequence, or a combination thereof. Query sets can be produced by manual grouping of items. In another example, a query set can be produced by techniques including, but not limited to text mining of sequence databases and literature, homology searches, annotation keyword searches, or any other technique that generates a group of items that are believed to share a common property. Query sets can comprise results from one or more biological experiments, for example as raw data or as a product of statistical or other data analyses.

As used herein, the term “query sequence” means a member of a query set. In one example, a query sequence is a nucleic acid or amino acid sequence. In one embodiment, query sequences can be grouped together to form one or more query sets. The query set(s) is/are then compared to a target database that has been organized into buckets, the members of each bucket sharing a common property.

As used herein, the term “reference biomolecule” refers to the members of the buckets that make up a target database. In one embodiment, a “reference biomolecule” is a “reference sequence”. Reference biomolecules are arranged in a target database into buckets, wherein the reference biomolecules in each bucket share a common property.

As used herein, the term “region set” or “regions sets” means a set containing at least some, and optionally all, of the known and predicted genes that lie within a contiguous region of a genome. A region set might have as its members all the genes either known or predicted to reside in one example on a certain chromosome, in another example on one arm of a certain chromosome, in another example on a portion of a chromosome contained between two markers, in another example on that area of a certain chromosome corresponding to a particular chromosomal band as visualized by G-banding with Giemsa stain, or in yet another example within a certain number of basepairs of each other on a certain chromosome. The certain number of basepairs can be measured in bases, kilobases, megabases, or cM.

As used herein, the term “relationship” means any association between one or more entities. Relationships include, but are not limited to nucleic acid and/or amino acid sequence similarity and/or identity, presence in the same region of a genome or being encoded by genes present in the same region of the genome, having the same or a similar function, containing or encoding a common functional domain, containing a common three-dimensional structural feature, association with a similar phenotype such as a disease state, involvement in the same biochemical pathway, and any combination thereof.

As used herein, the term “relevant universe of all characterized sequences” means all sequences that have been characterized to an extent sufficient to allow the user to conclude that the corresponding biomolecules should or should not be placed into a bucket. This conclusion can be based upon an assessment or a hypothesis as to whether or not a given biomolecule has the property shared by the members of a given bucket. When several complementary or competing sources exist for assigning biomolecules to a bucket (e.g., kinase buckets as defined from several different sources or methods) all can be included rather than attempting to choose one “best” set.

As used herein, the terms “significance” and “significant” relate to a statistical analysis of the probability that there is a non-random association, or a more unusual relationship, between two or more entities. In one example, “significance” refers to the probability that an observed relationship occurred by chance. To determine whether or not a relationship is “significant” or has “significance”, statistical manipulations of the data can be performed to calculate a probability, expressed as a “p-value”. Those p-values that fall below a user-defined cutoff point are regarded as significant. In one example, a p-value less than or equal to 0.05, in another example less than 0.01, in another example less than 0.005, and in yet another example less than 0.001, are regarded as significant.

The term “similarity” can be contrasted with the term “identity”. Similarity is determined using an algorithm including, but not limited to, the BLAST-based algorithms or the GAP program (available from the University of Wisconsin Genetics Computer Group, now part of Accelrys Inc., San Diego, Calif., United States of America). “Identity”, however, means a nucleic acid or amino acid sequence having the same nucleic acid or amino acid at the same relative position in a given family member of a gene family or in a homologous nucleic acid or amino acid in a different organism. Homology and similarity are generally viewed as broader terms than the term identity. Biochemically similar amino acids, for example, leucine/isoleucine or glutamate/aspartate, can be present at the same position in a biomolecule—these are not identical per se, but are biochemically “similar.” These are referred to herein as conservative differences or conservative substitutions. This differs from a conservative substitution or mutation at the DNA level, which is defined as a change in a nucleic acid residue that does not result in a change in the amino acid codon encoded by the DNA at the altered position (e.g., TCC to TCA, both of which encode serine).

As used herein, the term “size” as it relates to a query set, a target database bucket, a genome, or a relevant universe of all characterized sequences, means the number of members present in the referenced item. For example, the size of a query set or a target database bucket would be the number of candidate biomolecules or reference biomolecules that make up the query set or target database bucket, respectively. Similarly, the size of a genome is the number of genes present in a genome or the number of gene products encoded by those genes. Also similarly, the size of the relevant universe of all characterized sequences is the number of sequences that have been characterized sufficiently such that a user can either include or exclude a given biomolecule from a given bucket based upon the biomolecule having or lacking the property shared by the members of the bucket. The “size of the relevant universe” will typically be less than or equal to the size of the genome. It Is also possible to define an “effective size” for a bucket, or for an entire genome, by performing redundancy analysis. Thus, if several very closely related sequences exist within a bucket (several mutant versions of the same protein, for example), one can define the number of substantially different members to be the “effective size” for that bucket. A similar correction could be applied on a per-genome basis as well.

As used herein, the term “source of informative content” means any source of information that describes a relationship between biomolecules or assigns a property to a biomolecule. A source of informative content includes, but is not limited to an annotated database of nucleic acid or amino acid sequences. In this example, the annotations can include references to suspected functions, expression patterns, homologs or orthologs from the same or different species, presence on a particular microarray chip or in a particular cDNA library, or presence on a particular chromosome or region of a chromosome. Other non-limiting sources of informative content include journal articles, public databases, web pages or trees, scientific abstracts and/or posters, technical data sheets, or personal communications. Experimental results, whether raw or resulting from prior analysis, can also be sources of informative content.

As used herein, the term “target database” means a collection of descriptions of one or more reference biomolecules. The reference biomolecules described in the collection are arranged in the target database into one or more buckets, wherein the members of each bucket share a common property. The reference biomolecules are further arranged such that the members of a bucket can be compared to a query set.

II. Biomolecule Analysis

A representative embodiment is adapted to identify properties that are common between a query set and a target database. The method can be employed, for example, to identify the function of a gene product of one or more genes that form a query set.

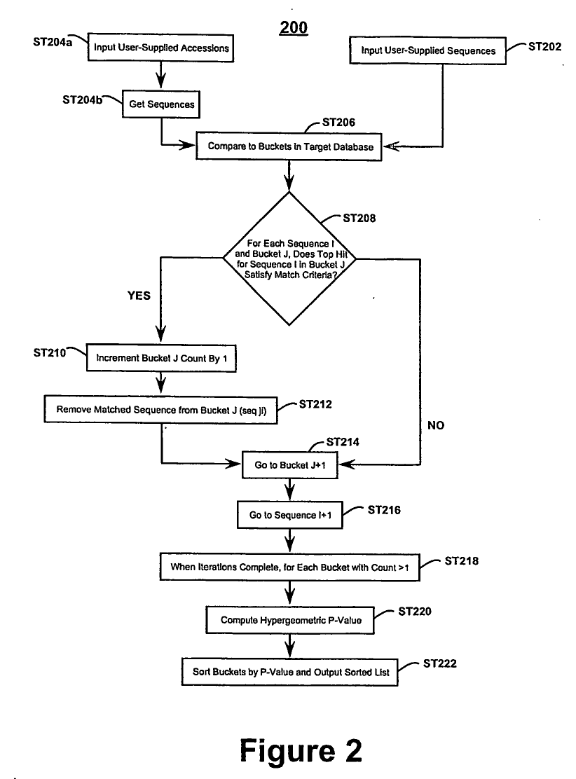

Referring now to FIG. 2, given a set of sequences (i.e., a query set) at steps ST202, ST204a, and ST204b comprising one or more query sequences, the query set is compared using the BLAST algorithms (Altschul et aL., 1990) to a target database comprising one or more sequences grouped into one or more buckets (FIG. 2 at step ST206). Each member of a query set is compared to each member of a target database. In one example, an embodiment can be configured to define a stringent threshold for filtering sequence match results. As shown in step ST208 of FIG. 2, in this configuration, if a query sequence possesses above-threshold matches to more than one sequence in the target database, only the best match in each bucket is counted and the count for that bucket is incremented by 1 as shown in FIG. 2 at step ST210. However, due to redundancy of the target database, a matching sequence can be a member of several different buckets of the target database. The query set can also contain redundancies, so once a candidate query set sequence has been matched to a given reference target database sequence, any subsequent matches to that same reference target database sequence in that bucket are ignored as shown in FIG. 2 at step ST212. Thus, irrespective of the size of the query set, a particular bucket can have no more matches than the number of reference sequences that the bucket contains. Once a candidate query set sequence is compared to all the reference target database sequences in a given bucket, that process is repeated for the candidate query set sequence with the reference target database sequences of the next bucket, as shown in FIG. 2 at step ST214. Once a given candidate query set sequence has been compared to all reference target database sequences, the process is repeated for the next candidate query set sequence as shown in FIG. 2 at step ST216. Once all candidate query set sequences have been compared to all reference target database sequences, each bucket with a count greater than 1 is collected as shown in FIG. 2 at step ST218.

As shown in FIG. 2 at step ST220, to account for the different sizes of the buckets (i.e., the different numbers of members that each bucket contains), a hypergeometric-distribution statistic is computed to assess the significance of the results. In this manner, a query set that matches 49 of 50 sequences in one bucket, for example, is considered to be a more significant result than a match of all 5 of 5 sequences from another bucket. Results are then sorted and displayed based on the computed hypergeometric-distribution statistic as shown in FIG. 2 at step ST222. A number of standard algorithmic and bioinformatic optimizations can be made to improve system performance, such as but not limited to one or more of the following: pre-computing all the biomolecule relationships and using a look-up table to determine biomolecule identity or similarity, storing the subset of buckets with a significant number of matches in an associate array, and limiting the statistical computation to that subset.

The problem of correlating a given query set with a target database is addressed. The methods and data structures disclosed herein can be readily implemented and employed in a range of applications. Additionally, the methods are able to tolerate small numbers of “contaminant” sequences in a bucket without significantly degraded performance.

II.A. Construction of Target Database

One property of the method is the generality of its application. Given any source of informative content about a particular set of biomolecules that share one or more common properties, the methods can create appropriate buckets and add them to an iterative, ever-expanding, and evolving target database. A target database thus comprises various classifications of biomolecules (e.g., genes and gene products) into collections, also known as “buckets”, of entities having one or more common properties.

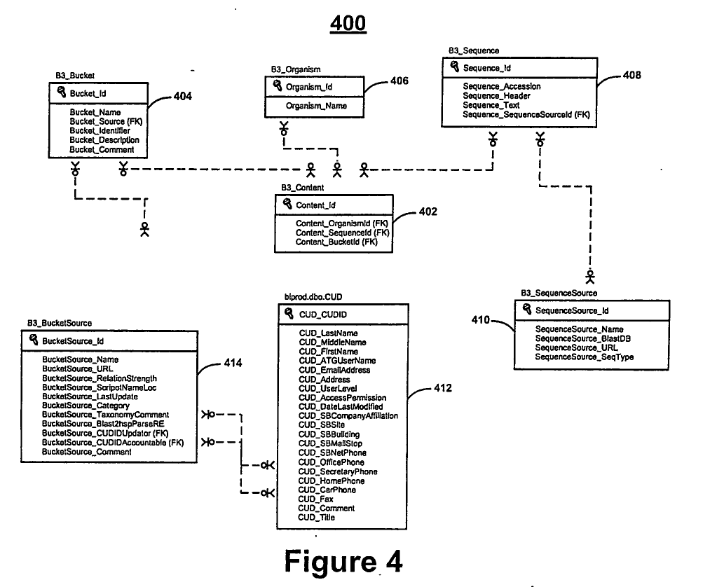

A target database can be constructed. For example, as shown in FIG. 4, a target database can be constructed by identifying a source of informative content (box 402 in FIG. 4), arranging the informative content into a set of named buckets (box 404 in FIG. 4) wherein the members of each bucket share a common property, gathering the names of the buckets and a list of the biomolecules present in each bucket; and creating and loading into a database several data fields containing data representing the set of buckets, the list of biomolecules present in each bucket, a description for each biomolecule present in each bucket; an organism source for the biomolecule; and the user who inputted the information (see e.g., boxes 406-412 in FIG. 4). This data can be present as a data structure having multiple data fields and stored on a computer-readable medium, as is generally referred to as 400 in FIG. 4. Interconnections between the data fields are schematically depicted by dashed lines in FIG. 4.

Referring now to boxes 408 and 410 in FIG. 4, in one embodiment, a bucket can comprise a unique name describing its contents (e.g., “kinases”), a list of its members, and the nucleic acid and/or amino acid sequences for each of its members. A nucleic acid or amino acid sequence can be stored in one example as a file containing the nucleic acid or amino acid sequence itself. In another example, a nucleic acid or amino acid sequence can be stored as an identification number or accession number instead of the sequence itself, wherein the identification number or accession number allows the corresponding nucleic acid or amino acid sequence to be accessed as needed from a public or private database. For example, if the human erythropoietin gene or gene product is a member of a bucket, it could be stored in that bucket as the entire nucleotide or amino acid sequence of the human erythropoietin gene or protein, respectively.

Continuing with boxes 408 and 410 in FIG. 4, alternatively, the appropriate NCBI or SwissProt accession number can be stored instead. A variety of biological information including nucleotide and peptide sequence information is available from public databases provided, for example, by the National Center for Biotechnology Information (NCBI) located at the United States National Library of Medicine (NLM). The NCBI is located on the World Wide Web at uniform resource locator (URL) “http://www.ncbi.nlm.nih.gov/”, and the NLM is located on the World Wide Web at URL “http://www.nlm.nih.gov/”. The NCBI website provides access to a number of scientific database resources including: GenBank, PubMed, Genomes, LocusLink, Online Mendelian Inheritance in Man (OMIM), Proteins, and Structures. A common interface to the polypeptide and polynucleotide databases is referred to as Entrez which can be accessed from the NCBI website on the World Wide Web at URL “http://www.ncbi.nlm.nih.gov/Entrez/” or through the LocusLink website. For the human erythropoietin gene and protein, for example, these accession numbers are AF202306 and P01588, respectively. In yet another example, the sequences can also be entered into, and subsequently retrieved from, a separate BLAST-formatted database. Each bucket entry can also contain a term describing the organism from which the reference sequence was derived (e.g., box 406 in FIG. 4). Each bucket entry can also contain additional information, such as standard nomenclature for the gene or protein represented by the bucket entry.

Continuing with FIG. 4, in another embodiment, provided is the incorporation of a user-created query set into a target database. In this example, each set of nucleic acid or amino acid sequences that is submitted as a query can itself become a new bucket. In this example, the identity of each user, box 412 in FIG. 4, can be tracked and the user required to enter the appropriate data into a common gateway interface (CGI) script-generated webpage. These “user buckets” can be treated in the same way as any other bucket. User buckets will likely be of varying quality, with some user buckets resulting from a thorough data analysis while other user buckets might be exploratory queries.

The addition of user buckets can result in an enhancement in a given target database. For example, it is possible to add any (or all) gene clusters, dose-response or time-course gene sets, and lists of genes with altered expression derived from any experiment to a target database. Such additions can be made available to an entire project, group, site, or a corporate entity. Further, by identifying the user responsible for adding a specific user bucket, (e.g., by using bucket source identifiers as discussed hereinbelow), any user who finds that his or her query set is similar to that of another user will be able to immediately recognize this event and notify the other user. Thus, communication of experimental results (e.g., results related to the implication of genes or gene products in different disease conditions) can be enhanced.

Continuing with FIG. 4, as the collection of buckets in a target database grows, it can be advantageous to define a “bucket source” 414 that describes the origin of each bucket. This can be desirable because two or more sources can often define buckets with exactly the same names, but with varying degrees of overlap in the sequence(s) that form the buckets. By including the source in a bucket name to form a “bucket source” identifier, the uniqueness of bucket names is assured. A further advantage of defining bucket sources is that it also facilitates defining broad categories of buckets, such as “pathway” or “function” buckets. This can be useful for helping to sort the output results or allowing users to choose and employ category types (i.e., buckets) that are most interesting or relevant to their work.

An ad hoc rating system for relative ranking of the quality of each bucket source is optionally employed. In this rating system, reliable human-annotated sources (e.g., SwissProt accessible via the World Wide Web at http://us.expasy.org/sprot/) can receive a higher rank than a set generated by an automated computational procedure.

Continuing with box 414 in FIG. 4, each bucket source can also have an associated file or URL comprising the raw data from which a given bucket was created, as well as a Perl script that parses the data and actually creates the bucket files. Since many data sources can be derived from public (e.g., SwissProt, TrEMBL, NCBI) or private databases (e.g., intra-corporation) that are continually changing, automated scripts can be employed for updating a target database collection periodically. There can also be some sets of buckets that are created once and need not be updated further. All buckets in the target database are stored in a relational database. A relational database enables rapid retrieval of data on any given biomolecule or bucket through the use of indexing.

II.B. Comparison of a Query Set with a Target Database

The comparing of a query set (e.g., a user-defined set of nucleic acid or amino acid sequences) with a target database is disclosed, as is scoring and ranking the matches, and reporting the results.

II.B.1. Searching a Target Database

Pre-computed relationships of identity or similarity between biomolecules from other sources can be used. The identity relationships can be based on equivalence of accessions, identifiers, or names of genes and proteins from data sources such as NCBI's LocusLink, Swissprot, or HUGO. Thus, any member of the query set with a name, accession, identifier, or sequence identical to one in the target database can be considered a match. This identity relationship can be determined by the use of associative arrays, string matching, or regular expressions. More domain specific techniques might be applied for biomolecule sequences, such as BLAST (Altschul et al., 1990) or dynamic programming. A database of these pre-computed relationships or a method for computing these relationships that determines the identity or similarity of a member of the query set to that of a reference biomolecules can be employed.

When all of the sequences comprising a query set and a target database comprise nucleic acid and/or protein sequences, the BLAST algorithms (Altschul et al., 1990) can be employed to rapidly perform pairwise nucleic acid-nucleic acid, protein-protein, or nucleic acid-protein comparisons between each member of the query set and each member of a target database. In one embodiment, stringent BLAST parameters can be employed to enforce a strict matching criterion, thereby reducing the comparison to a binary response (i.e. match/no match) for each sequence pair. Stringent BLAST parameters can include, but are not limited to, parameters that require that in order for a match to be scored, two sequences must be sufficiently identical (e.g. 95%, 96%, 97%, 98% or greater) and the match region must be sufficiently long (e.g. 100 or more residues, or encompassing the entire length of any biomolecule of less than 100 residues in length). In this regard, it is noted that each target database match is not only a match to a specific sequence, but also a match to the bucket(s) of which the sequence is a member.

BLAST is one approach to identifying a degree of similarity between two or more sequences. Software for performing BLAST analyses is publicly available through the National Center for Biotechnology Information (NCBI: http://www.ncbi.nlm.nih.gov/), and also can be licensed from Washington University, St. Louis, Mo., United States of America (http://blast.wustl.edu).

The basic BLAST algorithm involves first identifying high scoring sequence pairs (HSPs) by identifying short words of length W in a query sequence, which either match or satisfy some positive-valued threshold score T when aligned with a word of the same length in a database sequence. T is referred to as the neighborhood word score threshold. These initial neighborhood word hits act as seeds for initiating searches to find longer HSPs containing them. The word hits are then extended in both directions along each sequence until the cumulative alignment score falls a predetermined value below the maximum achieved score. Cumulative scores are calculated using, for nucleic acid sequences, the parameters M (reward score for a pair of matching residues; always >0) and N (penalty score for mismatching residues; always <0). For amino acid sequences, a scoring matrix is used to calculate the cumulative score. Extension of the word hits in each direction are halted when the cumulative alignment score decreases by the quantity X from its maximum achieved value, the cumulative score goes to zero or below due to the accumulation of one or more negative-scoring residue alignments, or the end of either sequence is reached. The BLAST algorithm parameters W. T. and X determine the sensitivity and speed of the alignment. For BLASTN searches, parameter settings such as “W=13; hitdist=28; M=1; N=−2; Q=1; R=1; X=6; gapw=20” from Washington University BLAST (WU-BLAST: http://blast.wustl.edu/blast/TO-FLY.html#blastn) can be employed. For protein searches, parameter settings of “W=4; T=1000; matrix=PAM10; E=1e-10” to determine identities can be used.

In addition to calculating percent sequence identity, the BLAST algorithm also performs a statistical analysis of the similarity between two sequences. See, e.g., Karlin and Altschul, 1993. One measure of similarity provided by the BLAST algorithm is the smallest sum probability (P(N)), which provides an indication of the probability by which a match between two nucleic acid or amino acid sequences would occur by chance. For example, a test nucleic acid sequence is considered similar to a reference sequence if the smallest sum probability in a comparison of the test nucleic acid sequence to the reference nucleic acid sequence is less than about 0.1, in another example less than about 0.01, and in still another example less than about 0.001.

Percent similarity of a DNA or peptide sequence can also be determined, for example, by comparing sequence information using the GAP computer program, available from the University of Wisconsin Genetics Computer Group (now part of Accelrys Inc., San Diego, Calif., United States of America). The GAP program utilizes the alignment method of Needleman and Wunsch (1970), as revised by Smith and Waterman (1981). Briefly, the GAP program defines similarity as the number of aligned symbols (i.e., nucleotides or amino acids) that are similar, divided by the total number of symbols in the shorter of the two sequences. See, e.g., Schwartz and Dayhoff, 1979, pp. 357-358, Gribskov and Burgess, 1986.

II.B.2. Counting Matches

In another aspect, guidelines are provided for counting matches. For example, when a candidate biomolecule of a query set matches a reference biomolecule of a target database (i.e. meets or exceeds a user-defined stringency requirement), a match is counted. When counting matches between sets, the following guidelines for counting matches can be employed:
a) each query set candidate biomolecule can be considered to match at most one reference biomolecule in any given bucket;
b) each query set candidate biomolecule can possess a match in one or more different buckets; and
c) once a candidate biomolecule in the query set matches a specific bucket reference biomolecule in the target database, any subsequent matches of that same candidate biomolecule to other reference biomolecules, or of other candidate biomolecules to the same reference biomolecule in that bucket, do not increase the match count for the bucket.

The third guideline ensures that for a query set with Q members and a bucket with B members, the two cannot share more matches than the minimum of B and Q. A result of a counting procedure is a list of all the buckets in a target database that have one or more matches to a given query set.

II.B.3. Statistical Significance of the Number of Matches

In another aspect, the number of matches between a member of a query set and a bucket of a target database identified and counted as described herein can be analyzed to determine the statistical significance of the match. That is, the number of matches can be analyzed to determine, generally speaking, the likelihood that the number of matches is due to random coincidence, as opposed to a true property in common between the query set and the bucket of the target database.

In general, the significance of a match will depend on the size of the query set, the size of each target database bucket that matched, the number of matches, and the total size of the relevant universe of all characterized sequences (approximated by the number of unique biomolecules in the reference collection). By way of example, the significance of a match can be modeled on the basis of a hypergeometric distribution as follows. If Q is the size of the query set, B is the size of a particular target database bucket that matched the query set, k is the number of matches between Q and B, and G is the size of the relevant universe, then the probability of exactly k matches is given by a hypergeometric distribution, which is defined as:
P(Q∩B=k)=C(B,k)C(G−B,Q−k)/C(G,Q)
where C(x,y) is the binomial coefficient: x!/[y!(x-y)!] and x! indicates factorial (the product of all integers from 1 to x). The P-value is indicated by the tail of the distribution:

$$P ( Q ⋂ B \geq k ) = {\sum }_{j = k}^{min ( B , Q )} ( C ( B , k ) C ( G - B , Q - k ) / C ( G , Q ) )$$

The parameter G can be fixed as a constant for all computations.

Although draft forms of the sequence of the human genome are available to the public for searching (See http://www.ncbi.nlm.nih.gov /genome/guide/human/), there is still no agreement on the number of genes or proteins it encodes. See e.g., Smaglik (2000), and compare Lander et al. (2001) estimating 30,000-40,000 protein-coding genes to Venter et al. (2001) estimating 38,000 genes. Although current estimates of the number of human genes range upwards from 20,000, many genes have not yet been characterized while others are likely incorrectly or incompletely characterized. There is no doubt that some genes have not yet been identified, so the true number of genes in the human genome is likely to be uncertain for many years to come. Therefore, any estimate made with respect to genome size is, to some extent, arbitrary.

An aspect, therefore, pertains to the characterization of the number of genes comprising the human genome as a number reflecting how many human genes have been identified, annotated, or otherwise classified. Regardless, the specific value for the genome size has no impact upon the rank order of the buckets that are reported as significant matches. This degree of uncertainty in the size of the genome only affects the cutoff level for statistical significance. Thus, the relative ordering of the buckets is unaffected by any assumptions made concerning the size of the genome. It is also possible to compute an effective size for the genome of any organism by counting up all the unique sequences from that organism that have been partitioned into one or more buckets. Similarly, one could restrict the genome size to the number of probe sets (or number of unique genes) available on a specific DNA microarray or chip, for purposes of analyzing experimental data from RNA expression studies.

In one embodiment, the results of comparing a query set to a target database can be presented as a list of buckets ranked by p-value, and can be bounded by a predefined statistical cutoff. In one embodiment, for each of the buckets in the results list, a hyperlink can be incorporated in an output display that takes the user to a summary page. The summary page can be configured to show which query set sequences matched which bucket elements, as well as which bucket elements had no matches in the query set. One or more additional hyperlinks can also be included. These hyperlinks include, but are not limited to links to a database entry for each query set sequence (such as a link to the entry in SwissProt, NCBI, or a private database).

II.B.4. Representative Steps

The following section describes an embodiment of the method. The section generally describes a series of steps that can be performed when practicing the disclosed method. The following steps describe only one example. Variations on the disclosed method will be apparent to those of ordinary skill in the art, upon consideration of the present disclosure, and are encompassed by the appended claims. Reference is also made to FIG. 2, where a method is referred to generally at 200.

First, as shown at step ST202 and/or ST204a and ST204b in FIG. 2, a query set comprising one or more candidate biomolecules is inputted to a computer that will run an analysis. A query set can comprise, for example, one or more sequences known or suspected to be located in the same genetic region. Alternatively, a query set can comprise an amino acid sequence of a protein known or suspected to be involved in a given biological pathway or complex, or can comprise a set of nucleotide or protein sequences which result from a biological experiment, such as gene or protein abundance changes, protein-protein interactions, etc. For convenience, sequences are inputted in the standard FASTA format. See Pearson, 1988 and Pearson, 1990. If the sequences of a query set are not in FASTA format, they can be converted to FASTA format. Additionally, the inputting can comprise entering accession identifiers and retrieving FASTA formatted sequences based on the identifiers, as depicted in steps ST204a and ST204b in FIG. 2.

Next, as shown in steps ST206 and ST208 in FIG. 2, a sequence I of one or more candidate biomolecules of a query set is compared with a sequence of one or more reference biomolecules of a target database, the one or more reference biomolecules of the target database grouped into one or more buckets J. The comparison can be made using a matching of equivalent biomolecules names, sequences or accession, or by BLAST-based identity/similarity search based on sequence. Such a search can employ the algorithms of the BLAST method. Alternatively, the search can employ modified BLAST algorithms. The selection of the search algorithms to be employed can be made based upon consideration of the sequences and the target database composition. A target database can be generated as disclosed herein. Buckets can also be generated as disclosed herein.

After a search has been performed, as shown in step ST208 of FIG. 2, a number of matches between each candidate biomolecule, e.g., sequence I, of the query set and each reference biomolecule in the target database are counted. This operation can generate a list detailing which candidate biomolecules of a query set matched which buckets, e.g., bucket J, (and which reference biomolecules) of a target database. Guidelines for counting matches are provided herein. The iterative capability of the present method is shown in steps ST210, ST212, ST214, ST216, and ST218, wherein the search continues to an additional bucket J+1.

Following a search, as shown in step ST220 of FIG. 2, one or more statistics (such as hypergeometric statistics or hypergeometric statistics including empirical correction multiple hypothesis testing) for each bucket match can be computed. Such a computation can account for the genome size G, and the query set size Q, and can be based on bucket size B and number of hits k. By performing a very stringent BLAST search, it is possible to assert whether or not a sequence is present in any given bucket, and should therefore be considered as possessing that biological property. By performing a statistical analysis, it can be determined how likely it would be for a similar result to have been obtained by chance, if choosing at random the same number of sequences in the input set. This enables the results to be ranked, with those properties shared by all (or a large subset) of the query set to receive greater priority than those properties that only occur in an individual sequence from the query set.

Standard cut-offs for p-values (such as 0.05, 0.01, 0.001) can be used to guide significance. These p-values can be corrected for multiple hypothesis testing using a suitable approach, such as but not limited to one or more of a conservative Bonferroni correction (which multiplies these values by the number of hypotheses tested equal to the number of buckets for this embodiment) and computing an empirical p-value based in simulations with random input sets. This empirical p-value can be obtained by using multiple random input sets of genes and computing the number of times any bucket is observed below a certain statistic. For example, the algorithm can be simulated 1000 times on random input sets of genes (each set with 50 members). The distribution of the best observed hypergeometric statistic from each of those 1000 computations can be plotted, and a statistic chosen, such that only 50 of the 1000 simulations have a statistic as good. This effectively gives the statistic that represents an empirical p-value of 0.05 for query sets of size 50. This can be repeated for query sets of varying sizes.

The results of the statistical operation can then optionally be sorted by increasing or decreasing significance, as shown in step ST222 of FIG. 2. The results of the operation can then be displayed to a user. Convenient display formats can include an output webpage. When results are displayed on a webpage, the results can be accompanied by hyperlinks to further details of the search, to the match, to the target database, and/or to the query set members.

III. Genomic Region Analysis

The methods disclosed herein can be employed to identify a property common to a set of candidate biomolecules from one genomic region that form a query set and a set of reference biomolecules that form one or more buckets of a target database. However, the present method is not limited to a comparison of a query set comprising a single set of candidate biomolecules and a target database. As described in the following sections, one embodiment of the method can be employed to identify a property common to a query set comprising two or more region sets and a target database. Representative steps are as follows:
a. providing a query set describing two or more region sets, each region set comprising one or more candidate sequences extracted from a genomic region;
b. comparing the query set with target database sequences describing one or more reference biomolecule sequences, the target database sequences grouped into one or more buckets, and wherein the one or more reference biomolecules of each bucket share a common property;
c. counting a number of matches between each query set and each bucket of the target database; and
d. statistically analyzing each match, wherein the presence of a statistically significant match identifies a relationship between the query set and the bucket of the target database.

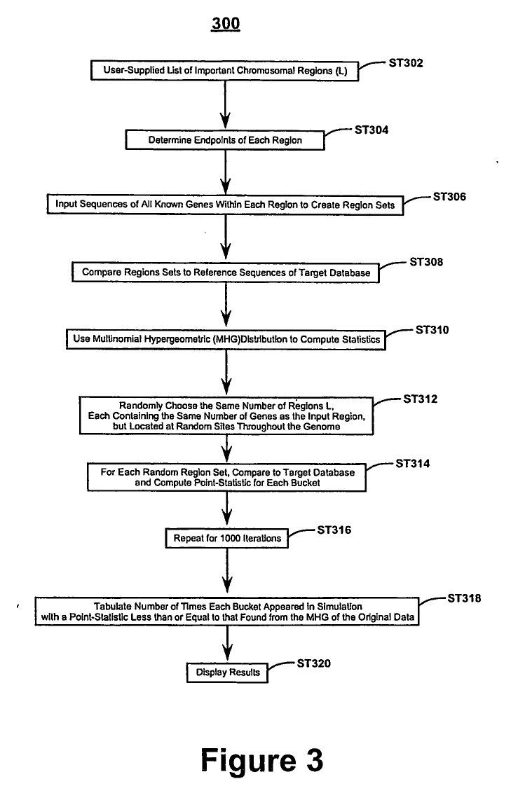

A non-limiting example of this embodiment can be described in the context of a disease gene association analysis, and is referred to generally at 300 in FIG. 3. As shown in step ST302 in FIG. 3, a given set of genomic regions known or suspected to be associated with a particular disease or general disease category is first identified. As shown in steps ST304 and ST306, for each such region, endpoints are determined and a set containing at least some and preferably all of the known and predicted genes that lie within the region is created. This set is known as a “region set”. Multiple region sets can be accommodated. Region sets can be combined to form a query set.

A query set, which comprises two or more region sets, is then compared, region set by region set, with a target database, at step ST308 in FIG. 3. The comparison can optionally be made by one of employing either the equivalency of name, identifier or accession, and by using BLAST or BLAST-based algorithm(s) on the sequences of the biomolecules. For each region set in a query set, if one of the candidate sequences of a region set matches a reference sequence in the target database, the matching sequence(s) is scored as “present” for that region.

Continuing with step ST308 in FIG. 3, each candidate sequence of a query set is sequentially compared with the reference sequences of the target database to generate a list of candidate sequences in the query set (which can be sorted by region set) that are present in the target database. The query set sequences that match a reference sequence in a target database can be sorted by target database set(s) (i.e., buckets) that contain at least one match from a specified number of different region sets. This process generates a list of buckets found in one or more region sets.

As shown at steps ST310, ST312, and ST314 in FIG. 3, the statistical significance of a match between a query set sequence and a target database set can then be calculated. The method can also be adapted to allow the results to be sorted and displayed on the basis of one or more criteria. The incorporated statistical analysis offers a step for ensuring that any observed result (e.g., a match between a query set sequence and a target database sequence) cannot be explained solely by random chance. In one example of such a statistical analysis, simulations are employed to randomly choose a set of genomic regions with similar gene numbers to the input data, to compare the simulation data to the sequences of a target database, and to score any matches observed. Subsequently, another random set of genomic regions is chosen and the process is repeated until a predetermined number of iterations or replicates has been performed. In one example, and as depicted in step ST316 of FIG. 3, iterations are done for 1000 random region sets. Then, the results of the simulation are compared with data obtained from an actual query set, as shown in step ST318 in FIG. 3. Actual data set matches that rank statistically highly in the simulation can be considered to be potential false positives and can be discarded as not indicative of a meaningful match. The results of the statistical analysis can then be displayed, as shown in step ST320 in FIG. 3. For example, for a bucket appearing with statistic of 0.01 in the actual analysis, if in the 1000 simulations that bucket appears with that statistic or better only 50 times, then this bucket is assigned an empirical p-value of 0.05. This would be less significant than the p-value based on the theoretical statistic alone.

III.A. Searching a Target Database

The steps summarized immediately above will now be discussed in detail. The identification of one or more properties of a candidate sequence of a query set can be achieved by searching a target database of reference sequences that have been grouped into buckets representing groups of sequences that have the same properties. Such a search can follow another experiment, the results of which can form elements of a query set. Some technologies and experiments generate a powerset of genes, for example S =(S₁S₂ . . . Sₙ). A subsequent goal is then to find a property P such that there is at least one gene in a significant number of sets Sₖ that has property P. The sets S₁ . . . Sₙ have no pairwise intersection (e.g., non-overlapping genomic regions). Thus if biological pathways are considered as potential properties, then the goal might be to find a pathway that threads or connects these sets of genes.

Consider a linkage analysis experiment, where genetic markers have been genotyped in both a disease and a normal population and log of the odds ratio (LOD) scores have been obtained across the human genome. For most common diseases, multiple linkage peaks are observed. The presence of multiple linkage peaks can be explained as:
none of the linkage peaks are real; OR
some of the higher linkage peaks are real, and each peak has one or more genes in the corresponding genomic region, mutations in which explain the observed linkage

If the latter proposition is true, then one of the following cases must apply.
these mutated genes are independent (they do not share any property, such as a pathway) OR
(H) a subset of these genes is related by a property, such as a pathway, and mutations in a subsection of this pathway all contribute to the same phenotype/disease
   III.B. Counting Matches

Exploration of known properties that might explain hypothesis H above can be accomplished using a genomic region analysis embodiment. Consider n genomic regions with corresponding region sets of genes: S₁,S₂ . . . Sₙ. If an additional set of genes R is added to (S₁,S₂ . . . Sₙ), where R contains all remaining genes not in S₁ . . . Sₙ, then the superset (S₁ . . . Sₙ, R) can be considered a partition on the human genome. Thus, consider the data superset S=(S₁ . . . Sₙ, R) and let the number of genes with property P overlapping with these sets be (P_{J1} . . . P_{Jn}, Pⱼᵣ). The probability of this event (or partition j) is given by the multivariate form of the hypergeometric distribution (sampling without replacement):

$$P ( {event}_{j} ) = C ( R , {P}_{jr} ) {\prod }_{k = 1}^{n} C ( {S}_{k} , {P}_{jk} ) / C ( Genome , \vert P \vert )$$

where C( ) is the binomial coefficient, and |S| is the cardinality (i.e., the number of members) of the set S. The probability of seeing this by chance can be estimated by summing the above term over all events −j that would be considered significant, for examples, events that have at 3 or more Pⱼₖ greater than 0.

In certain applications, it might only be important that the region set S have at least one biomolecule in common (or identical) to that with property P. It might not add any more evidence if it has two or more molecules with property P. In such cases, computing an exact significance (p-value) becomes a difficult task, and Monte-Carlo techniques can be used to acquire estimates as discussed in the next section

III.C. Statistical Significance of Matches

Statistical measures make assumptions of independence among set members that do not completely hold for biological sequences. Thus, the significance of any result is assessed using negative controls. True negative controls are hard to obtain, as that would require knowing that a certain powerset of biological sequences shares no property in a significant measure. A solution is to generate multiple random sets and use simulations to compute the background frequency of a property. A similar approach is adopted here. A plurality of replicates of a query set is constructed. These replicates are matched to the query set in the sense that the number of genes in each replicate is equal to the number of genes in each set of the powerset and as far as possible arises from a similar bioinformatics process. The replicates are then modeled at random chromosomal locations to form a random location data set. The random location data set is then processed using the same method steps described above. For example, if the original powerset represented linkage regions, then each random set would be a set of contiguously ordered genes from a single chromosome, and a random set of genes from a contiguous region of the genome can be generated. For each property, the number of times that property is observed in the random powerset is counted with P(event) equal to or lower than that observed in the actual powerset. This provides a simulation-based or empirical p-value.

A similar approach can also be used in the analysis of time-series data, such as data gathered from microarray expression experiments over time. For example, some experiments produce a list of genes with significantly perturbed expression at the earliest time point, and various other sets that experienced expression changes at successively later time points. Some pathway or process that connects this set of measurements can also be identified. As an example, assume that there were three time-points measured—(E)arly, (I)ntermediate, and (L)ate. For each time point there would be an associated set of genes (E_{I}, I_{I}, L_{I}) whose expression levels had changed relative to the control (time=0). If these sets are non-overlapping, one can apply the method to discover any processes that contain one or more genes that are present in each timepoint set, thus forming a hypothesis as to the pathway and the causal steps involved in the experimental process. Statistical corrections are employed to handle the case where the sets are not completely disjoint.

By way of additional example, schizophrenia is a multifactorial disease. A number of linkage studies have been published implicating the following chromosomal regions: 1q21-22, 1q32-42, 6p24-22, 8p21, 10p14, 13q32, 18p11, and 22q11-13. Blouin et al., 1998; Berrettini, 2000; Straub et al., 1995; Brzustowicz et al., 2000; Ekelund et al., 2001. For the chromosome 1q region, conflicting evidence also exists. Levinson et al., 2002. Given suitable markers or other methods to determine the physical boundaries of each region, one can extract the set of known and predicted genes within each such region. The genome region analysis' embodiment is then used to probe for pathways or other biological processes that have components in some or all of the linkage regions. Simulations can also be performed to repeatedly generate randomly located chromosomal regions of comparable size and gene content to assess whether the results occur frequently by chance alone. The findings are then used as hypotheses for guiding experimental studies.

### EXAMPLES

The following Examples have been included to illustrate certain embodiments. Certain aspects of the following Examples are described in terms of techniques and procedures found or contemplated to work well in the practice of the embodiments. These Examples are exemplified through the use of standard practices of applicants. In light of the present disclosure and the general level of skill in the art, those of skill will appreciate that the following Examples are intended to be exemplary only and that numerous changes, modifications, and alterations can be employed without departing from the spirit and scope of the present disclosure.

### Example 1

### Pseudocode

If input not FASTA format, read accessions and get FASTA sequences,
Compare input sequences against entire bucket database (use BLAST-based identity search or simply accession ID lookup),
For each input sequence, count number of matches to each bucket in database,
Given the genome-size G, and the query set-size Q, compute hypergeometric statistic for each bucket possessing matches, based on bucket-size B and number of hits k.
Sort the results list by decreasing significance and output webpage with results and hyperlinks to further details.

### Example 2

### Analysis of Genes Regulated by E2F₁

Stanelle reported 29 genes as being regulated by the transcription factor E2F₁. Stanelle et al., 2002. The authors divided this set of genes into five categories: cell cycle, apoptosis, cancer-related, E2F₁ targets, and unknown. Submitting the same unordered list in an embodiment of the present method results in a ranked list of approximately 100 buckets significant at p≦0.05. Presently there are approximately 80,000 buckets in the target database. These buckets have been created from a combination of publicly available databases and internal experimental results. These buckets cover many types of biological data including, but not limited to genomic location, diseases, tissue expression, functions, pathways, transcriptional regulation, families, domains, and literature abstracts. The most significant hits of this input set to the target database are shown in Table 1. Some of the sources which appear are keywords and families from Swissprot, protein domains from EnsEMBL Interpro, human disease sets from OMIM, and sets derived from the Gene Ontology Consortium website and NCBI's LocusLink. This list includes several overlapping buckets related to each of the known categories supplied by the authors, with cyclin C (cell-cycle) determined to be the most significant bucket. In addition to confirming the authors' classifications, more specific links, such as associations with MAPKKK signaling and multiple myeloma, were also uncovered. See Table 1.

TABLE 1
Results of Classifying the Set of Genes Regulated by
Transcription Factor E2F₁

| Bucket Name | Bucket Source | Bucket Size | Obs | Exp | p Value |
|---|---|---|---|---|---|
| Cyclin_C | EnsEMBL InterPro Domains | 12 | 4 | 0.046 | 8.7e−08 |
| Apoptosis: BP | LocusLink GO | 227 | 9 | 0.88 | 1.1e−07 |
| Cell Death: BP | LocusLink GO | 236 | 9 | 0.91 | 1.5e−07 |
| Death: BP | LocusLink GO | 236 | 9 | 0.91 | 1.5e−07 |
| Induction Of Apoptosis: BP | LocusLink GO | 90 | 6 | 0.35 | 9.6e−07 |
| G1/S-Specific Cyclin: MF | GOA | 9 | 3 | 0.035 | 4.3e−06 |
| Cyclin | EnsEMBL InterPro Domains | 33 | 4 | 0.13 | 6.8e−06 |
| Cyclin | SwissProt Keyword | 18 | 3 | 0.07 | 4.1e−05 |
| E2F1 | OMIM | 18 | 3 | 0.07 | 4.1e−05 |
| Cyclin | SwissProt Family | 19 | 3 | 0.073 | 4.8e−05 |
| Cyclin: MF | GOA | 19 | 3 | 0.073 | 4.8e−05 |
| Apoptotic Mitochondrial | LocusLink GO | 4 | 2 | 0.015 | 8.6e−05 |
| Changes: BP | | | | | |
| Apoptotic Program: BP | LocusLink GO | 25 | 3 | 0.09 | 0.0001 |
| Myeloma, Multiple | OMIM | 5 | 2 | 0.019 | 0.00014 |
| Induction Of Apoptosis By | LocusLink GO | 30 | 3 | 0.12 | 0.00020 |
| Extracellular Signals: BP | | | | | |
| MAPKKK Cascade: BP | LocusLink GO | 34 | 3 | 0.13 | 0.00029 |

### Example 3

### Pseudocode Genomic Region Analysis Embodiment

For each genomic region of interest, extract at least some and preferably all of the known genes contained therein.
For each region set, compare each candidate sequence to the bucket collection (use BLAST-based identity search or simply accession ID lookup).
For each bucket in the database, count number of region sets that contain at least one biomolecule in common with the bucket.
Choose some constant M≦number of regions, and report all buckets that had hits to at least M regions.
Use multivariate form of hypergeometric distribution to assess significance of these buckets.
Given the number of regions and number of genes in each region, construct 1000 replicates of the region set (same number of regions and same number of genes per region), but placing the simulated regions at random chromosomal locations.
Process this random data set in the same way as the real data, and note how many times (out of 1000 replicates) that each bucket was found with at least as strong statistical support as it had in the original data set.
Display the results, ranked by decreasing statistical support in the original data.

### References

The references listed below as well as all references cited in the specification are incorporated herein by reference to the extent that they supplement, explain, provide a background for or teach methodology, techniques, and/or compositions employed herein.
Altschul S F, Gish W, Miller W, Myers E W and Lipman D J (1990) Basic Local Alignment Search Tool. J Mol Biol 215:403-410.
Aurora R and Rose GD (1998) Seeking an Ancient enzyme in Methanococcus jannaschii Using ORF, a Program Based on Predicted Secondary Structure Comparisons. Proc Natl Acad Sci USA 95:2818-2823.
Berrettini W H (2000) Are Schizophrenic and Bipolar Disorders Related? A Review of Family and Molecular Studies. Biol Psychiatry 48:531-538.
Blaschke C, Oliveros J C and Valencia A (2001) Mining Functional Information Associated with Expression Arrays. Funct Integr Genomics 1:256-268.
Blouin J L et al. (1998) Schizophrenia Susceptibility Loci on Chromosomes 13q32 and 8p21. Nat Genet 20:70-73.
Bouton C M and Pevsner J (2000) Dragon: Database Referencing of Array Genes Online. Bioinformatics 16:1038-1039.
Bouton C M and Pevsner J (2002) Dragon View: Information Visualization for Annotated Microarray Data. Bioinformatics 18:323-324.
Brzustowicz L M, Hodgkinson K A, Chow E W, Honer W G and Bassett A S (2000) Location of a Major Susceptibility Locus for Familial Schizophrenia on Chromosome 1q21-Q22. Science 288:678-682.
del Rio G, Bartley T F, del-Rio H, Rao R, Jin K L, Greenberg D A, Eshoo M and Bredesen D E (2001) Mining DNA Microarray Data Using a Novel Approach Based on Graph Theory. FEBS Lett 509:230-234.
Ekelund J, Hovatta I, Parker A, Paunio T, Varilo T, Martin R, Suhonen J, Ellonen P, Chan G, Sinsheimer J S, Sobel E, Juvonen H, Arajarvi R, Partonen T, Suvisaari J, Lonnqvist J, Meyer J and Peltonen L (2001) Chromosome 1 Loci in Finnish Schizophrenia Families. Hum Mol Genet 10:1611-1617.
Gribskov M and Burgess R R (1986) Sigma Factors from E. Coli, B. Subtilis, Phage Sp01, and Phage T4 Are Homologous Proteins. Nucleic Acids Res 14:6745-6763.
Halushka M K, Mathews D J, Bailey J A and Chakravarti A (1999) Gist: A Web Tool for Collecting Gene Information. Physiol Genomics 1:75-81.
Henikoff S and Henikoff J G (1992) Amino Acid Substitution Matrices from Protein Blocks. Proc Natl Aced Sci U S A 89:10915-10919.
Jenssen T K, Laegreid A, Komorowski J and Hovig E (2001) A Literature Network of Human Genes for High-Throughput Analysis of Gene Expression. Nat Genet 28:21-28.
Karlin S and Altschul S (1993) Applications and Statistics for Multiple High-Scoring Segments in Molecular Sequences. PNAS 90:5873-5877.
Khatri P, Draghici S, Ostermeier G C and Krawetz S A (2002) Profiling Gene Expression Using onto-Express. Genomics 79:266-270.
Lander E S et al. (2001) Initial Sequencing and Analysis of the Human Genome. Nature 409:860-921.
Levinson D F et al. (2002) No Major Schizophrenia Locus Detected on Chromosome 1q in a Large Multicenter Sample. Science 296:739-741.
Masys D R, Welsh J B, Lynn Fink J, Gribskov M, Klacansky I and Corbeil J (2001) Use of Keyword Hierarchies to Interpret Gene Expression Pattems. Bioinformatics 17:319-326.
McGuffin L J & Jones D T (2002) Targeting novel folds for structural genomics. Proteins 48:44-52.
Needleman S B and Wunsch C D (1970) A General Method Applicable to the Search for Similarities in the Amino Acid Sequence of Two Proteins. J Mol Biol 48:443-453.
Nelson M R, Kardia S L, Ferrell RE and Sing C F (2001) A Combinatorial Partitioning Method to Identify Multilocus Genotypic Partitions That Predict Quantitative Trait Variation. Genome Res 11:458-470.
Ostermeier G C, Dix D J, Miller D, Khatri P, Krawetz S A (2002) Spermatozoal RNA Profiles of Normal Fertile Men. Lancet 360:772-7.
Pavlidis P, Weston J, Cai J and Noble W S (2002) Learning Gene Functional Classifications from Multiple Data Types. J Comput Biol 9:401-411.
Pearson W R (1990) Rapid and Sensitive Sequence Comparison with FASTP and FASTA. Methods Enzymol 183:63-98.
Pearson W R and Lipman D J (1988) Improved Tools for Biological Sequence Comparison. Proc Natl Acad Sci USA 85:2444-2448.
Perez-Iratxeta C, Bork P and Andrade M A (2002a) Association of Genes to Genetically Inherited Diseases Using Data Mining. Nat Genet 31:316-319.
Perez-lratxeta C, Keer H S, Bork P and Andrade M A (2002b) Computing Fuzzy Associations for the Analysis of Biological Literature. Biotechniques 32:1380-1382,1384-1385.
Ritchie M D, Hahn L W, Roodi N, Bailey L R, Dupont W D, Parl F F and Moore J H (2001) Multifactor-Dimensionality Reduction Reveals High-Order Interactions among Estrogen-Metabolism Genes in Sporadic Breast Cancer. Am J Hum Genet 69:138-147.
Schwartz R M and Dayhoff M O. (1979). Atlas of Protein Sequence and Structure. National Biomedical Research Foundation. Washington, D.C.
Smaglik (2000) Researchers Take a Gamble on the Human Genome. Nature 405:264.
Smith T and Waterman M (1981) Comparison of Biosequences. Adv Appl Math 2:482-489.
Stanelle J, Stiewe T, Theseling C C, Peter M and Putzer B M (2002) Gene Expression Changes in Response to E2F1 Activation. Nucleic Acids Res 30:1859-1867.
Straub R E et al. (1995) A Potential Vulnerability Locus for Schizophrenia on Chromosome 6p24-22: Evidence for Genetic Heterogeneity. Nat Genet 11:287-293.
Tanabe L, Scherf U, Smith L H, Lee J K, Hunter L and Weinstein J N (1999) Medminer: An Internet Text-Mining Tool for Biomedical Information, with Application to Gene Expression Profiling. Biotechniques 27:1210-1214, 1216-1217.
Venter J C et al. (2001) The Sequence of the Human Genome. Science 291:1304-1351.

It will be understood that various details can be changed without departing from the scope of the disclosure. Furthermore, the foregoing description is for the purpose of illustration only, and not for the purpose of limitation. Indeed, variations on the present disclosure will be apparent to those of ordinary skill in the art, upon consideration of the present disclosure, and are encompassed by the appended claims.

What is claimed is:

1. A method of identifying a relationship between one or more candidate biomolecules and one or more reference biomolecules, the method comprising:
(a) inputting to a computer a query set describing the one or more candidate biomolecules;
(b) comparing the query set with a target database describing the one or more reference biomolecules, wherein the one or more reference biomolecules are grouped into one or more buckets, and wherein the one or more reference biomolecules of each bucket share a common property;
(c) counting a number of matches between each query set and each bucket of the target database; and
(d) statistically analyzing each match, wherein the presence of a statistically significant match identifies a relationship between the query set and a bucket of the target database.

2. The method of claim 1, wherein the query set comprises one or more sequences.

3. The method of claim 2, wherein the one or more sequences are selected from the group consisting of a DNA sequence, an RNA sequence, and a protein sequence.

4. The method of claim 2, wherein the one or more sequences are extracted from one genetic region.

5. The method of claim 1, wherein the one or more candidate biomolecules and the one or more reference biomolecules are all selected from the group consisting of proteins, nucleic acids, and small molecules.

6. The method of claim 1, wherein the comparing comprises employing an equivalence algorithm based on identity of name, accession, or other identifier associated with biomolecule.

7. The method of claim 1, wherein the comparing comprises employing a BLAST-based algorithm to identify similarities or identities in two or more sequences.

8. The method of claim 1, wherein the counting comprises applying one or more principles chosen from the group consisting of:
(a) each query set candidate sequence can match at most one reference sequence in any given bucket;
(b) each query set candidate sequence can possess a match in one or more different buckets; and
(c) once a candidate sequence in the query set matches a specific bucket reference sequence in the target database, any subsequent matches of that same candidate sequence to other reference sequences in that bucket do not increase the match count for the bucket.

9. The method of claim 1, wherein the statistically analyzing comprises computing one or more statistics for each bucket.

10. The method of claim 8, further comprising sorting the one or more statistics by increasing or decreasing significance.

11. The method of claim 1, further comprising outputting a webpage with results of the statistical analysis, the webpage comprising one or more hyperlinks.

12. A computer-readable storage device embodying a program of instructions executable by a computer to perform method steps for identifying a relationship between one or more candidate biomolecules and one or more reference biomolecules, the method steps comprising:
(a) inputting to a computer a query set describing one or more candidate biomolecules;
(b) comparing the query set with a target database describing one or more reference biomolecules, the one or more reference biomolecules of the target database grouped into one or more buckets, wherein the one or more reference biomolecules of each bucket share a common property;
(c) counting a number of matches between each query set and each bucket of the target database; and
(d) statistically analyzing each match, wherein the presence of a statistically significant match identifies a relationship between a query set and one or more buckets of a target database.

13. The computer-readable storage device of claim 12, wherein the query set comprises one or more candidate sequences.

14. The computer-readable storage device of claim 13, wherein the one or more candidate sequences are selected from the group consisting of a DNA sequence, an RNA sequence, and a protein sequence.

15. The computer-readable storage device of claim 13, wherein the one or more candidate sequences are extracted from one genetic region.

16. The computer-readable storage device of claim 12, wherein the one or more candidate biomolecules and the one or more reference biomolecules are all selected from the group consisting of proteins, nucleic acids, and small molecules.

17. The computer-readable storage device of claim 12, wherein the comparing comprises employing a BLAST-based algorithm to identify similarities or identities in two or more sequences.

18. The computer-readable storage device of claim 12, wherein the comparing comprises employing a equivalence algorithm based on identity of name, accession, or other identifier associated with biomolecule.

19. The computer-readable storage device of claim 12, wherein the counting comprises applying one or more principles chosen from the group consisting of:
(a) each query set candidate sequence can match at most one reference sequence in any given bucket;
(b) each query set candidate sequence can possess a match in one or more different buckets; and
(c) once a candidate sequence in the query set matches a specific bucket reference sequence in the target database, any subsequent matches of that same candidate sequence to other reference sequences in that bucket do not increase the match count for the bucket.

20. The computer-readable storage device of claim 12, wherein the statistically analyzing comprises computing one or more statistics for each match.

21. The computer-readable storage device of claim 20, further comprising sorting the one or more statistics by increasing or decreasing significance.

22. The computer-readable storage device of claim 12, further comprising outputting a webpage with results of the statistically analyzing, the webpage comprising one or more hyperlinks.

23. A method of identifying a relationship between two or more region sets, each region set describing one or more candidate biomolecules, and a target database describing one or more reference biomolecules grouped into one or more buckets, the method comprising:
(a) providing a query set describing two or more region sets, each region set comprising one or more candidate biomolecule sequences extracted from one region;
(b) comparing the query set with target database sequences describing one or more reference biomolecule sequences, wherein the target database sequences are grouped into one or more buckets, and wherein the one or more reference biomolecules of each bucket share a common property;
(c) counting a number of matches between each query set and each bucket of the target database; and
(d) statistically analyzing each match, wherein the presence of a statistically significant match identifies a relationship between the query set and the bucket of the target database.

24. The method of claim 23, wherein the one or more biomolecule sequences are selected from the group consisting of protein sequences and nucleic acid sequences.

25. The method of claim 24, wherein the nucleic acid sequences are selected from the group consisting of a DNA sequence and an RNA sequence.

26. The method of claim 23, wherein the comparing comprises employing a equivalence algorithm based on identity of name, accession, or other identifier associated with biomolecule.

27. The method of claim 23, wherein the comparing comprises employing a BLAST-based algorithm to identify similarities or identities in two or more sequences.

28. The method of claim 23, wherein the counting comprises applying one or more principles chosen from the group consisting of:
(a) each query set candidate sequence can match at most one reference sequence in any given bucket;
(b) each query set candidate sequence can possess a match in one or more different buckets; and
(c) once a candidate sequence in the query set matches a specific bucket reference sequence in the target database, any subsequent matches of that same candidate sequence to other reference sequences in that bucket do not increase the match count for the bucket.

29. The method of claim 23, wherein the statistically analyzing comprises computing one or more statistics for each match.

30. The method of claim 29, further comprising sorting the one or more statistics by increasing or decreasing significance.

31. The method of claim 30, further comprising further comprising outputting a webpage with results of the statistically analyzing, the webpage comprising one or more hyperlinks.

32. The method of claim 23, the method further comprising:
(a) constructing a plurality of replicates of the one or more query sets;
(b) modeling the replicates at random chromosomal locations to form a random location data set;
(c) processing the random location data set by following the steps of claim 23;
(d) quantifying the number of times each match is found to surpass a predetermined threshold to form a statistically significant set of random location matches; and
(e) comparing the statistically significant set of random location matches to the statistically significant relationship of claim 23.

33. A computer-readable storage device embodying a program of instructions executable by a computer to perform method steps for identifying a relationship between two or more region sets, each region set each region set describing one or more candidate biomolecules, and a target database describing one or more reference biomolecules grouped into one or more buckets, the method steps comprising:
(a) providing a query set describing two or more region sets, each region set comprising one or more candidate biomolecule sequences extracted from one genetic region;
(b) comparing the query set with target database sequences describing one or more reference biomolecule sequences, wherein the target database sequences grouped into one or more buckets, and wherein the one or more reference biomolecules of each bucket share a common property;
(c) counting a number of matches between each query set and each bucket of the target database; and
(d) statistically analyzing each match, wherein the presence of a statistically significant match identifies a relationship between the query set and the bucket of the target database.

34. The computer-readable storage device of claim 33, wherein the one or more candidate biomolecule sequences and the one or more reference biomolecules sequences are all selected from the group consisting of protein sequences and nucleic acid sequences.

35. The computer-readable storage device of claim 34, wherein the nucleic acid sequences are selected from the group consisting of a DNA sequence and an RNA sequence.

36. The computer-readable storage device of claim 33, wherein the comparing comprises employing a BLAST-based algorithm to identify similarities or identities in two or more sequences.

37. The computer-readable storage device of claim 33, wherein the counting comprises applying one or more principles chosen from the group consisting of:
(a) each query set candidate sequence can match at most one reference sequence in any given bucket;
(b) each query set candidate sequence can possess a match in one or more different buckets; and
(c) once a candidate sequence in the query set matches a specific bucket reference sequence in the target database, any subsequent matches of that same candidate sequence to other reference sequences in that bucket do not increase the match count for the bucket.

38. The computer-readable storage device of claim 33, wherein the statistically analyzing comprises computing one or more statistics for each match.

39. The computer-readable storage device of claim 38, further comprising sorting the one or more statistics by increasing or decreasing significance.

40. The computer-readable storage device of claim 39, further comprising outputting a webpage with results of the statistically analyzing, the webpage comprising one or more hyperlinks.

41. The computer-readable storage device of claim 33, the method steps further comprising:
(a) constructing a plurality of replicates of the one or more query sets;
(b) modeling the replicates at random chromosomal locations to form a random location data set;
(c) processing the random location data set by following the steps of claim 33;
(d) quantifying the number of times each match is found to surpass a predetermined threshold to form a statistically significant set of random location matches; and
(e) comparing the statistically significant set of random location matches to the statistically significant relationship of claim 33.

42. A computer-readable medium having stored thereon a data structure having multiple data fields comprising:
(a) a first data field containing data representing a bucket;
(b) a second data field containing data representing a name for the bucket; and
(c) a third data field containing data representing a list of members of the bucket, wherein the members have a common property.

43. The computer-readable medium of claim 42; further comprising a data field containing data representing an organism from which each of the members of the bucket are derived.

44. The computer-readable medium of claim 42, further comprising a data field containing data representing a bucket source.

45. The computer-readable medium of claim 44, further comprising a data field containing data representing data for creating the bucket.

46. The computer-readable medium of claim 44, further comprising a Perl script that parses data and creates a bucket file.

47. The computer-readable medium of claim 42, further comprising a data field containing data representing standard nomenclature for each reference biomolecule that is a member of the bucket.

48. The computer-readable medium of claim 42, further comprising a data field containing data representing a sequence for a member of the bucket.

49. The computer-readable medium of claim 48, wherein the data representing a sequence for a member of the bucket is a nucleic acid sequence.

50. The computer-readable medium of claim 48, wherein the data representing a sequence for a member of the bucket is an amino acid sequence.

51. The computer-readable medium of claim 48, wherein:
(a) the data representing a sequence for a member of the bucket is an identification number, and
(b) the identification number allows for retrieval of the sequence.

52. The computer-readable medium of claim 51, wherein the identification number is an accession number wherein the accession number allows for retrieval of the sequence from a database.

53. The computer-readable medium of claim 52, wherein the database is chosen from the group consisting of a publicly available database and a private database.

54. The computer-readable medium of claim 53, wherein the publicly available database is chosen from the group consisting of SwissProt, TrEMBL, and NCBI.

55. A method of making a target database, the method comprising:
(a) identifying a source of informative content;
(b) arranging informative content from the source of informative content into a set of buckets, wherein the buckets are given names;
(c) gathering the names of the buckets and a list of biomolecules present in each bucket; and
(d) creating and loading into a database data fields containing data representing:
(i) the set of buckets;
(ii) the list of biomolecules present in each bucket; and
(iii) a description for each biomolecule present in each bucket.

56. The method of claim 55, wherein the source of informative content is a publicly available database.

57. The method of claim 56, wherein the publicly available database is chosen from the group consisting of SwissProt, TrEMBL, and NCBI.

58. The method of claim 55, wherein the gathering is accomplished using a source-specific parsing script.

59. The method of claim 55, wherein the creating and loading is accomplished using a database loading script.

60. The method of claim 55, wherein the data representing a description for each biomolecule present in each bucket is selected from the group consisting of a nucleic acid sequence, an amino acid sequence, or an identification number, wherein the identification number allows for retrieval of a nucleic acid sequence or an amino acid sequence.

61. A computer-readable storage device embodying a program of instructions executable by a computer to perform method steps for making a target database, the method steps comprising:
(a) identifying a source of informative content;
(b) arranging informative content from the source of informative content into a set of buckets, wherein the buckets are given names;
(c) gathering the names of the buckets and a list of biomolecules present in each bucket; and
(d) creating and loading into a database data fields containing data representing:
(i) the set of buckets;
(ii) the list of biomolecules present in each bucket; and
(iii) a description for each biamolecule present in each bucket.

62. The computer-readable storage device of claim 61, wherein the source of informative content is a publicly available database.

63. The computer-readable storage device of claim 62, wherein the publicly available database is chosen from the group consisting of SwissProt, TrEMBL, and NCBI.

64. The computer-readable storage device of claim 61, wherein the gathering is accomplished using a source-specific parsing script.

65. The computer-readable storage device of claim 61, wherein the creating and loading is accomplished using a database loading script.

66. The computer-readable storage device of claim 61, wherein the data representing a description for each biomolecule present in each bucket is selected from the group consisting of a nucleic acid sequence, an amino acid sequence, or an identification number, wherein the identification number allows for retrieval of a nucleic acid sequence or an amino acid sequence.
